(19) United States
(12) Patent Application Publication
(10) Pub. No.: US 2014/0359077 A1
(43) Pub. Date: Dec. 4, 2014

(54) METHOD AND APPARATUS FOR TRANSMITTING SYMBOL FILES

(71) Applicant: QUALCOMM Incorporated, San Diego, CA (US)

(72) Inventors: Daein CHUNG, San Diego, CA (US); Sreekanth BOGA, San Diego, CA (US); Vineeth VIJAYAKUMARAN, San Diego, CA (US); Chencheng Wu, San Diego, CA (US)

(73) Assignee: QUALCOMM Incorporated, San Diego, CA (US)

(21) Appl. No.: 14/108,018

(22) Filed: Dec. 16, 2013

Related U.S. Application Data
(60) Provisional application No. 61/829,237, filed on May 30, 2013.

(51) Int. Cl. H04L 29/08

(52) U.S. Cl. CPC H04L 67/06
USPC 709/219

(57) ABSTRACT

The present disclosure presents a method and an apparatus for transmitting symbol files. For example, the method may include storing one or more symbol files at a local server, identifying a symbol file associated with a crash dump file by parsing the crash dump file, and determining whether the identified symbol file is to be transmitted to a central symbol server. Furthermore, such an example method may include retrieving the identified symbol file from the local server based at least on the determining, and transmitting the retrieved symbol file to the central symbol file server based at least on the determining. As such, transmission of symbol files is achieved.

### CLAIM OF PRIORITY UNDER 35 U.S.C. §119

The present application for patent claims priority to U.S. Provisional Patent Application No. 61/829,237, filed May 30, 2013, entitled “Method and Apparatus for Transmitting Symbol Files,” which is assigned to the assignee hereof, and hereby expressly incorporated by reference herein.

### BACKGROUND

Aspects of the present disclosure relate generally to computers and networks and, more particularly, to a method and an apparatus for transmitting symbol files.

During development and testing of hardware, software, and/or firmware, developers or engineers encounter scenarios where an application may crash and generate one or more files, generally called as crash dump files. The crash dump files generally are analyzed by developers to understand the reasons behind the application crash. However, the analysis of crash dump files is time consuming and may get worse if the developers used symbol files they received from other vendors (for example, a symbol file from a manufacturer of a chip set used in the product the developers are testing) in their testing and customized the symbol files for testing purposes.

In an environment, where developers customize the symbol files for testing purposes, the management of the symbol files and associating a symbol file to a crash dump file may consume a lot of time and may be error prone as there may be multiple versions of the symbol files lying around. The problem may get worse if there is no central repository for storing and managing the symbol files. As the symbol file is essential for a developer during the debugging process, the developers cannot complete the debugging process without identifying which symbol file to use for debugging a particular crash dump file

Therefore, there is a desire for a method and an apparatus for managing symbol files.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for transmitting symbol file. In an aspect, a method for transmitting symbol files is described. The method may include storing one or more symbol files at a local server, identifying a symbol file associated with a crash dump file by parsing the crash dump file, determining whether the identified symbol file is to be transmitted to a central symbol server, retrieving the identified symbol file from the local server based at least on the determining, and transmitting the retrieved symbol file to the central symbol file server based at least on the determining.

In an additional aspect, an apparatus for transmitting symbol files is described. The apparatus may include means for storing one or more symbol files at a local server, means for identifying a symbol file associated with a crash dump file by parsing the crash dump file, means for determining whether the identified symbol file is to be transmitted to a central symbol server, means for retrieving the identified symbol file from the local server based at least on the determining, and means for transmitting the retrieved symbol file to the central symbol file server based at least on the determining.

Moreover, the present disclosure presents a computer program product for transmitting symbol files is described. The computer program product may include at least one instruction for storing one or more symbol files at a local server, identifying a symbol file associated with a crash dump file by parsing the crash dump file, determining whether the identified symbol file is to be transmitted to a central symbol server, retrieving the identified symbol file from the local server based at least on the determining, and transmitting the retrieved symbol file to the central symbol file server based at least on the determining.

In a further aspect, an apparatus for transmitting symbol files is described. The apparatus may include a symbol file storing component configured to store one or more symbol files at a local server, a symbol file identifying component configured to identify a symbol file associated with a crash dump file by parsing the crash dump file, a symbol file transmitting detecting component configured to determine whether the identified symbol file is to be transmitted to a central symbol server, a symbol file retrieving component configured to retrieve the identified symbol file from the local server based at least on the determining, and a symbol file transmitting component configured to transmit the retrieved symbol file to the central symbol file server based at least on the determining.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an aspect of a system for transmitting symbol files;

FIG. 2 is a block diagram of an aspect of a local symbol server manager of the present disclosure;

FIG. 3 is a flow diagram illustrating aspects of a method for transmitting symbol files;

FIG. 4 is a block diagram illustrating aspects of a logical grouping of electrical components for transmitting symbol files as contemplated by the present disclosure;

FIG. 5 is a block diagram of an aspect of a computer device of the present disclosure; and

FIG. 6 is a block diagram illustrating an example of a hardware implementation for an apparatus employing a processing system;

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described aspects relate to methods and apparatuses for transmitting symbol files that may include storing one or more symbol files at a local server, identifying a symbol file associated with a crash dump file by parsing the crash dump file, determining whether the identified symbol file is to be transmitted to a central symbol server, retrieving the identified symbol file from the local server based at least on the determining, and transmitting the retrieved symbol file to the central symbol file server based at least on the determining.

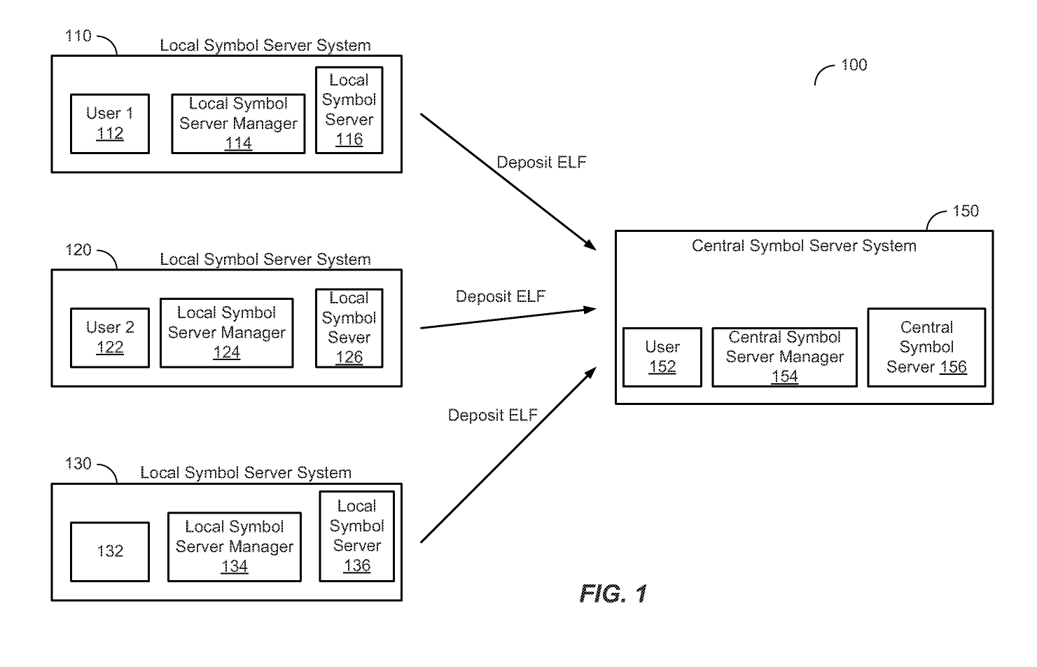

Referring to FIG. 1, a system 100 is illustrated for transmitting symbol files. System 100 includes one or more local symbol server systems, 110, 120 and/or 130, and a central symbol server system 150.

In an aspect, for example, a local symbol server system may be local symbol server system 110 operated by a vendor, for example, handset or user equipment (UE) manufacturer that may receive symbol files from a manufacturer of a chip set used in the handsets. The handset vendor may use the received symbol files for testing the handsets. In an additional or optional aspect, the handset manufacturer may customize the symbol files received from the chip manufacturer which may result in multiple versions of symbol files that may be stored at local symbol server 116. In an additional or optional aspect, local symbol server 116 may store symbol files that are customized and/or non-customized.

In an example aspect, local symbol server system 110 may be configured to include one or more users, for example, user 112, local symbol server manager 114, and local symbol server 116. In an aspect, for example, user 112 may be a developer or an engineer on a computing platform, for example, a desktop or a laptop computer or any similar device, that can access local symbol server 116 via a user interface, for example, a web based interface running on a commercially available web browser or a graphical user interface (GUI). In an aspect, local symbol server manager 114 may be a web based application running on a computer which may be used by user 112 to access local symbol server 116.

In an aspect, local symbol server system 110 may store symbol files received from other vendors, for example, chip set or processor manufacturers, and store the receive symbol files locally at local symbol server 116. The symbol files stored at local symbol server 116 may be executable linkable format (ELF) files or any other equivalent format. The ELF file format may be used for symbol files as ELF is flexible and is generally not bound to any particular processor or architecture. As a result, the ELF format files may work on many different operating systems and/or platforms with different architectures.

In an additional aspect, local symbol server systems 110, 120, and/or 130 may communicate with each other. For example, if local symbol server system 110 is used for testing by Research & Development (R&D) teams of a handset vendor and local symbol server system 120 is used by verification/validation teams, local symbol server systems 110 and 120 may communicate with each other to ensure that only one symbol file of a particular version (i.e., with a unique identifier) is sent to central symbol server system 150 to avoid unnecessary transmission of duplicate symbol files.

Central symbol server system 150 may be configured to include one or more users 152 and one or more central symbol servers 156. In an aspect, for example, user 152 may be a developer or an engineer on a computing platform, for example, a desktop or a laptop computer or any similar device, that may access central symbol server 156 via a user interface, for example, a web based interface running on a commercially available web browser or a graphical user interface (GUI). In an aspect, central symbol server manager 154 may be a web based application running on a computer which may be used by user 152 to access central symbol server 156.

In an aspect, the symbol files stored at central symbol server 156 may be stored in ELF format or any other equivalent format. The ELF file format, as described above, may be used for symbol files as ELF is flexible and is generally not bound to any particular processor or architecture. As a result, the ELF format files may work on many different operating systems and/or platforms with different architectures. In an additional aspect, central symbol server system 150 may include a plurality of central symbol servers for load balancing and/or redundancy.

In an aspect, the present disclosure includes a distributed system with a web based interface that addresses the problems associated with lack of a mechanism for managing symbol files. In an example aspect, symbol files may be embedded with Uniquely Identifiable Sentinels (UIS) to differentiate one symbol file from another symbol file. In an example aspect, a sentinel may be generated by concatenating a text string with a globally unique identifier (GUID). For example, a GUID may be a 136-bit integer used to identify resources and generally used by a developer. The GUID may be generated by a build tool during image generation and followed by a timestamp procured at the start of the build process.

The above described mechanism ensures that a GUID is embedded in a symbol file for every symbol file build. In an aspect, the sentinel may be placed in a read only data section of the symbol file, for example, “.rodata” section of an ELF file, which ensures that the sentinel is also available in a crash dump. In an additional aspect, the symbol files may be directly injected from a build system into central symbol server system 156. This keeps the central symbol server system current with the symbol files. In an additional or optional aspect, for example, SCon may be modified to include ‘signature=GUID in .rodata (read only section) of an ELF. A crash dump file will have the same ‘signature=GUID’ of its corresponding symbol file.

In an aspect, central symbol server system may maintain one or more central symbol servers to store symbol files that may be used by one or more of users 152 for testing purposes. In an additional aspect, central symbol server system may keep a record of symbol files downloaded from central symbol server 156 by users 152.

Additionally, central symbol server system secures downloads and uploads of all symbol files by housing a database of valid users. Central symbol server system 150 may be periodically updated for a new build of a particular image. Central symbol server system 150 may also purge out symbol files that are old and not needed any more. Central symbol server system may also archive some of the older symbol files depending on whether they may be required in the future and/or their importance. In an additional or optional aspect, central symbol server system 150 may also co-ordinate with local symbol server systems for syncing up with published symbol files.

In an aspect, each local symbol server system may have its own web technology and a dedicated local symbol server of its own. In an aspect, the local symbol servers may be considered as clients of central symbol server system 156.

In an aspect, local symbol server system 110 may either publish or hide the existence of a symbol file to central symbol server 156. Symbol files that are chosen to be published may be transmitted to central symbol server and symbol files that are configured as private are not transmitted to the central symbol server and are only stored locally at the local symbol server. For example, if a symbol is configured as private at local symbol server 116, it will not be transmitted to central symbol server 156. However, if a symbol file is configured as public at local symbol server 116, it may be transmitted to central symbol server 156.

In an aspect, symbol files may be valid and/or available only for a pre-configured amount of time at the central symbol server. The local symbol server can configure the amount of time the symbol files may be visible at the central symbol server prior to transmission from the local symbol server.

Thus, the goal of the mechanism described above disclosure is to provide a user with an integrated solution starting from intelligent procuring of symbol files, for example, (by interacting with customer request systems, to the point of assessing the crash, providing results of the analysis of crash dump files, and transmitting symbol files to a central server when needed.

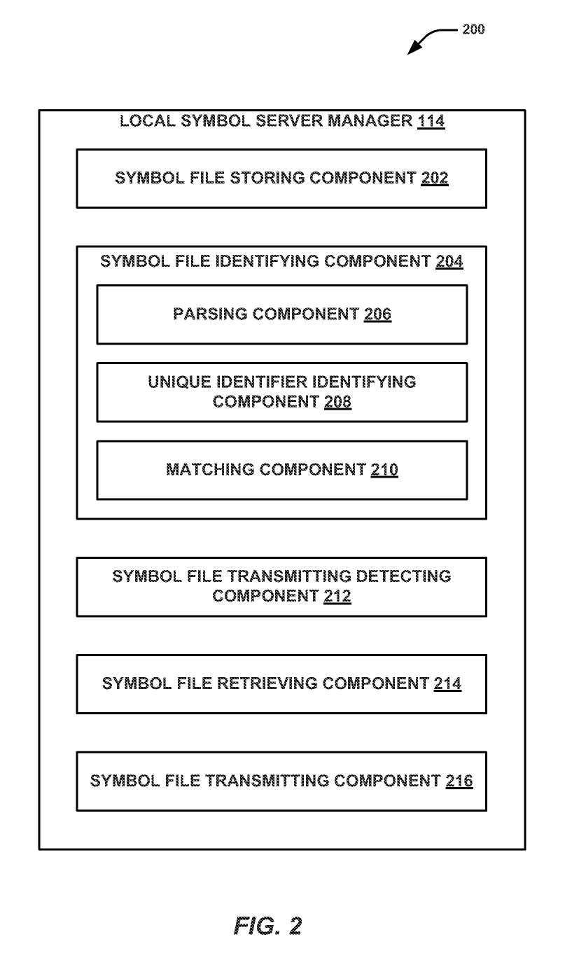

FIG. 2 illustrates an aspect of local symbol server manager that may be configured to transmit symbol files to a central symbol server. In an aspect, for example, local symbol server manager 114 may be configured to transmit symbol files to central symbol server 156. In an aspect, local symbol server manager 114 may be a web based interface for user 112 to access local symbol server 116 and/or transmit symbol files to central symbol server 156. For example, local symbol server manager 114 may be a web based application that can be launched by user 112 for transmitting symbol files from local symbol server 116 to central symbol server 156.

In an aspect, local symbol server manager 106 may be configured to include a symbol file storing component 202, a symbol file identifying component 204, a symbol file transmitting detecting component 212, a symbol file retrieving component 214, and/or a symbol file transmitting component 216.

In an aspect, symbol file storing component 202 may be configured to receive and/or store symbol files at local symbol server 116. The symbol files may be received from third party vendors, for example, a chip set or a processor vendor. In an additional or optional aspect, symbol files may be received from central symbol server system 150 which may be a vendor of chip sets or processors used in the manufacturing of a hand set or UE. In an optional aspect, local symbol server system 110 may sign up with central symbol server system 150 for automatically receiving symbol files when central symbol server 156 gets populated with new symbol files. In an additional or optional aspect, local symbol server 116 may be configured to receive only a limited type or limited number of symbol files.

In an aspect, once symbol files are received from central symbol server system 150 or manually stored at local symbol server 116, users of local symbol server system 110, for example, user 112, may customize the received/stored symbol files, for example, to suit needs of local symbol server system. In one example, one or more symbol files may be customized and stored at local symbol server 116.

In an aspect, symbol file identifying component 204 may be configured to include a parsing component 206, a unique identifier identifying component 208, and/or a matching component 210.

In an aspect, symbol file identifying component 204 and/or parsing component 206 may be configured to parse a crash dump file for identifying the symbol file associated with a crash dump file. During parsing of the crash dump file, web browsers may search the crash dump files which are large in size, for example, around 2 GB. In an aspect, the parsing of crash dump file may be performed efficiently by asynchronously reading and searching portions of the crash dump file. For example, the parsing can be performed using chunks of random access memory (RAM) dump around 2 MB in size (for example, 2 MB granularity).

In an aspect, symbol file identifying component 204 and/or unique identifier identifying component 208 may be configured to extract unique identifier from crash dump file. In an example aspect, unique identifier identifying component 208 may identify the unique identifier, for example, a uniquely identifiable sentinel (UIS) from the crash dump file.

In an aspect, for example, the symbol files are equipped with a unique sentinel that may help in distinguishing one symbol file from another symbol file. The sentinel may be generated by concatenating a text string with a GUID generated by the build tool during the image build, followed by the time stamp procured at the start of the build process. This mechanism may ensure that for every image build there is a globally unique identifier for a particular symbol file. In an aspect, the sentinel may be placed in the .rodata (read only data) of the symbol files (ELF format) to enable the sentinel available in the crash dump file. The symbol files may be directly injected from the build integration system into the central symbol server system that can be downloaded and used by developers/engineers as needed.

In an aspect, symbol file identifying component 204 and/or matching component 210 may be configured to match the extracted unique identifier to a symbol file stored at local symbol server 116. For example, once the unique identifier identifying component 208 extracts the unique identifier, matching component may search a database present at local symbol server 116 which keeps track of the symbol files stored at the local symbol server to identify the symbol file associated with the crash dump file. This can be done by just comparing the unique identifier of the crash dump file with the unique identifier of the stored symbol file.

In an aspect, symbol file transmitting detecting component 212 may be configured to search a database at the local server to determine whether the identified symbol file was transmitted to the central symbol server. For example, a database at local symbol sever 116 may keep track of symbol files that are transmitted earlier to central symbol sever 156. This mechanism allows avoiding transmission of symbol files that may have been already transmitted by the local symbol server earlier. This may eliminate duplication and avoid storing of unnecessary symbol files at central symbol server 156.

In an additional aspect, symbol files transmitted from local symbol server to central symbol server may include additional parameters. For example, the transmitted symbol files may be configured with an expiration date at the central symbol server prior to transmission to the central symbol server. Once a symbol file reaches its expiration date at the central symbol server, the central symbol server may delete the symbol file. In an additional or optional aspect, the central symbol server may move the symbol file to an archive, for future use.

In an additional or optional aspect, a symbol file may be set as private or public at the local symbol serve. For example, if a symbol file is set as “public,” symbol file transmitting detecting component 212 may transmit the symbol file to central symbol server 156. If the symbol file is set to “private,” symbol file transmitting detecting component 212 will not be transmit the symbol file to the central symbol server.

In an aspect, symbol file retrieving component 214 may be configured to retrieve the identified symbol file from the local server based at least on the determination that the identified symbol file is to be transmitted to the central symbol server. For example, if symbol file transmitting detecting component 212 detects that the symbol file has to be transmitted, the symbol file retrieval component 214 will retrieve the identified symbol file from the local symbol server.

In an aspect, symbol file transmitting component 216 may be configured to transmit the retrieved symbol file to central symbol file server based at least on the determination that the symbol file has to be transmitted and after retrieving the file from the local symbol server.

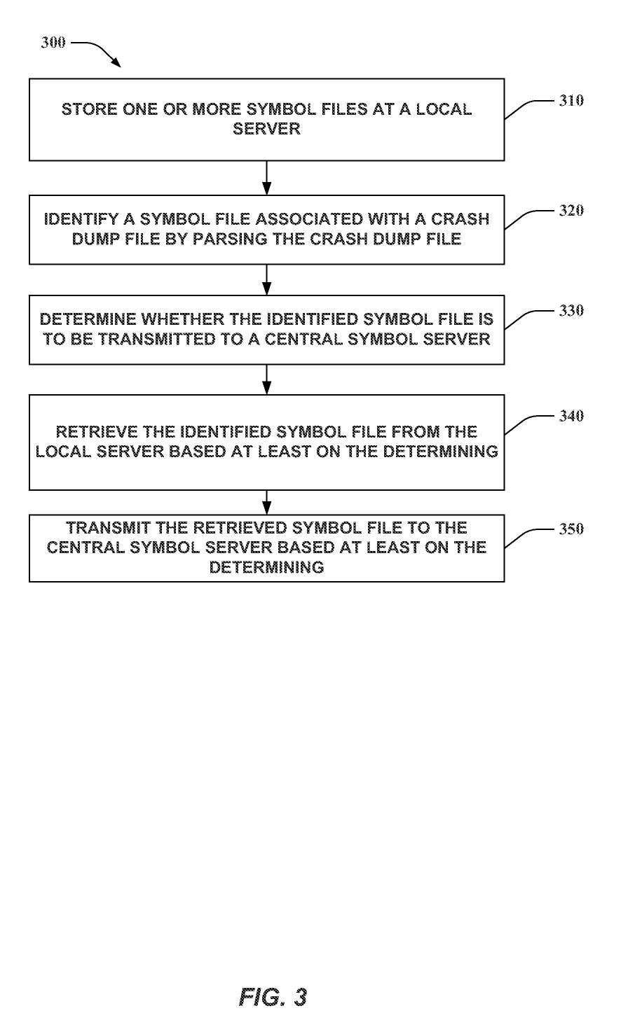

FIG. 3 illustrates an example methodology 300 for transmitting symbols from a local symbol server system to a central symbol server. For example, in an aspect, local symbol server manager 114 and/or local symbol server 116 may transmit a symbol file to central symbol server system 150 and/or central symbol server 156.

At block 310, methodology 300 may include storing one or more symbol files at a local symbol server. For example, local symbol server manager 114 and/or symbol file storing component 202 may store one or more symbol files at local symbol server 116. In an aspect, for example, the symbol files may be stored in an executable linkable format (ELF) which is a well known file format for executables, object code, shared libraries, and core dumps.

At block 320, methodology 300 may include identifying a symbol file associated with a crash dump file from the one or more symbol files stored at the local server by parsing the crash dump file. For example, in an aspect, symbol file identifying component 204 and/or parsing component 206 may parse the crash dump file looking for a unique identifier as described above. In an additional aspect, parsing component may extract a unique identifier from the crash dump file and/or a matching component 210 may match the unique identifier identified by the unique identifier identifying component 208 to a symbol file stored at local symbol server 116. In an aspect, for example, the unique identifier may be a sentinel in the crash dump file.

In an additional or optional aspect, parsing component 206 may parse the crash dump file efficiently by searching and reading the crash dump file asynchronously. For example, parsing component 206 may read crash dump file in chunks, for example, with 2 MB of granularity, and perform the search. The improved reading and searching algorithms may be more reliable by preventing crashes when parsing crash dump files.

Furthermore, in an aspect, for example, symbol file identifying component 204 may be configured to further include a matching component 210 that matches the extracted unique identifier or sentinel to a symbol file stored at a local symbol server.

At block 330, methodology 300 may include determining whether identified symbol file is to be transmitted to a central symbol server. In an aspect, for example, symbol file transmitting determining component 212 determines whether a symbol file identified above is to be transmitted to central symbol sever 156. For example, this can be determined by searching a database at local symbol server 116. The database at local symbol server 116 maintains a list of symbol files that were transmitted to central symbol server 156. This allows unnecessary transmittal of symbol server files to the central server. For example, if the search of the database reveals that the symbol file was transmitted before, the symbol file will not be transmitted again. This avoids unnecessary transmission of symbol files from local symbol servers and saves disk space at the central symbol server.

At block 340, methodology 300 may include retrieving the identified symbol file from the local server based at least on the determining. For example, symbol file retrieval component 214 may retrieve a symbol file from the local symbol server if it is determined that the symbol file was not transmitted earlier to central symbol sever 156 based on searching of the database at local symbol server 116. In an aspect, the retrieval of a symbol file from the local symbol server may include getting the file ready for transmission in case it has to be transmitted to the central symbol server. For example, the file may be compressed and checked for any corruption prior to transmitting to the central symbol server.

At block 350, methodology 300 may include transmitting the retrieved symbol file to the central symbol file server based at least on the determining. In an aspect, for example, symbol file transmitting component 216 may transmit the symbol file retrieved by symbol file retrieving component 214 to central symbol server 156.

The methodology 300 is shown and described as a series of acts, it is to be understood and appreciated that the methodologies are not limited by the order of acts, as some acts may, in accordance with one or more aspects, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more aspects.

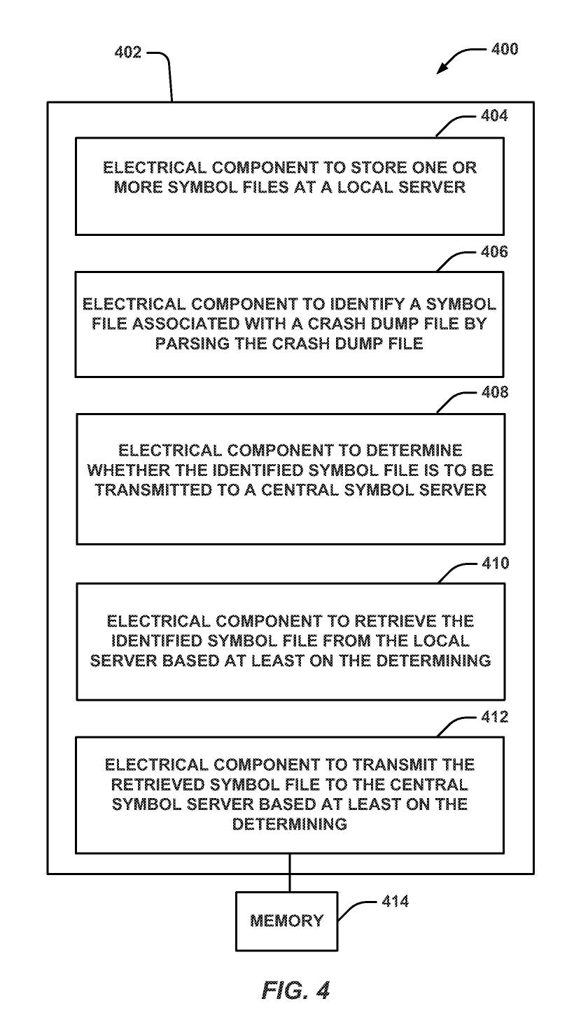

Referring to FIG. 4, an example system 400 is displayed for transmitting symbol files. For example, system 400 can reside partially within local symbol server system 110 (FIG. 1). It is to be appreciated that system 400 is represented as including functional blocks, which can be functional blocks that represent functions implemented by a processor, software, or a combination thereof (for example, firmware). System 400 includes a logical grouping 402 of electrical components that can act in conjunction. For instance, logical grouping 402 can include an electrical component 404 for storing one or more symbol files at a local server. In an aspect, for example, electrical component 404 may comprise symbol file storing component 202 (FIG. 2).

Additionally, logical grouping 402 can include an electrical component 406 for identifying a symbol file associated with a crash dump file by parsing the crash dump file. In an aspect, for example, electrical component 406 may comprise symbol file identifying component 204, parsing component 206, unique identifier identifying component 208, and/or matching component (FIG. 2).

Further, logical grouping 402 can include an electrical component 408 for determining whether the identified symbol file is to be transmitted to a central symbol server. In an aspect, for example, electrical component 408 may comprise symbol file transmitting detecting component 212.

Furthermore, logical grouping 402 can include an electrical component 410 for retrieving the identified symbol file from the local server based at least on the determining. In an aspect, for example, electrical component 410 may comprise symbol file retrieving component 214.

Additionally, logical grouping 402 can include an electrical component 412 for transmitting the retrieved symbol file to the central symbol file server based at least on the determining. In an aspect, for example, electrical component 412 may comprise symbol file transmitting component 216.

The methodology 400 is shown and described as a series of acts, it is to be understood and appreciated that the methodologies are not limited by the order of acts, as some acts may, in accordance with one or more aspects, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more aspects.

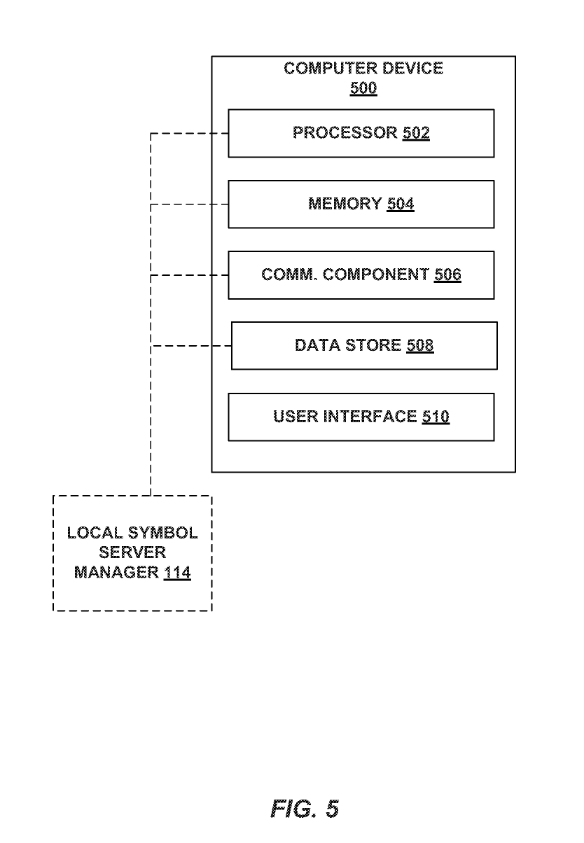

Referring to FIG. 5, an aspect of a computer device 500 may be specially programmed or configured to perform the respective functions described herein of any one of the various components of local symbol server manager 114. For example, in one aspect, computer device 500 may include local symbol server manager 114, symbol file storing component 202, symbol file identifying component 204, parsing component 206, unique identifier identifying component 208, matching component 210, symbol file transmitting detecting component 212, symbol file retrieving component 215, and/or symbol file transmitting component 216, as shown in FIGS. 1-4.

Computer device 500 includes a processor 502 specially configured to carry out processing functions associated with one or more of components and functions described herein. Processor 502 can include a single or multiple set of processors or multi-core processors. Moreover, processor 502 can be implemented as an integrated processing system and/or a distributed processing system. For example, processor 502 may be configured to execute the described functions of local symbol server manager 114, symbol file storing component 202, symbol file identifying component 204, parsing component 206, unique identifier identifying component 208, matching component 210, symbol file transmitting detecting component 212, symbol file retrieving component 215, and/or symbol file transmitting component 216, as shown in FIGS. 1-4.

Computer device 500 further includes a memory 504, such as for storing data used herein and/or local versions of applications and/or instructions or code being executed by processor 502, such as to perform the respective functions of the respective entities described herein. Memory 504 can include any type of memory usable by a computer, such as random access memory (RAM), read only memory (ROM), tapes, magnetic discs, optical discs, volatile memory, non-volatile memory, and any combination thereof. For example, memory 504 may be configured to store symbol files and/or databases related to transmitted symbol files to central symbol server as described herein with respect to local symbol server manager 114.

Further, computer device 500 includes a communications component 506 that provides for establishing and maintaining communications with one or more parties utilizing hardware, software, and services as described herein. Communications component 506 may carry communications between components on computer device 500, as well as between computer device 500 and external devices, such as devices located across a communications network and/or devices serially or locally connected to computer device 500. For example, communications component 506 may include one or more buses, and may further include transmit chain components and receive chain components associated with a transmitter and receiver, respectively, or a transceiver, operable for interfacing with external devices. For example, communications component 506 may be configured to perform the communications functions described herein of local symbol server manager 114 and/or components of the local symbol server manager 114.

Additionally, computer device 500 may further include a data store 508, which can be any suitable combination of hardware and/or software, that provides for mass storage of information, databases, and programs employed in connection with aspects described herein. For example, data store 508 may be a data repository for applications not currently being executed by processor 502. For example, data store 508 may be configured to store symbol files and/or database information associated with local symbol server manager 114.

Computer device 500 may additionally include a user interface component 510 operable to receive inputs from a user of computer device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof. For example, user interface component 510 may be configured to receive user input from local symbol server manager 110 (e.g., images, registration information and associated information).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. A storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

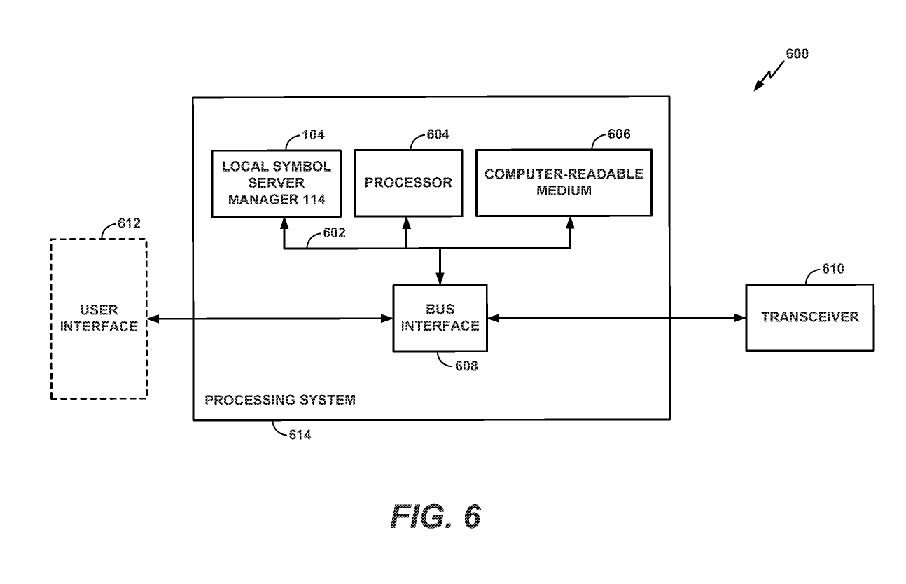

FIG. 6 is a block diagram illustrating an example of a hardware implementation for an apparatus 600, for example, including local symbol server manager 114 (FIGS. 1-2), employing a processing system 614 for carrying out aspects of the present disclosure, such as a method for transmitting symbol files. In this example, the processing system 614 may be implemented with bus architecture, represented generally by a bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, and one or more components described herein, such as, but not limited to, local symbol server manager 114, symbol file storing component 202, symbol file identifying component 204, parsing component 206, unique identifier identifying component 208, matching component 210, symbol file transmitting detecting component 212, symbol file retrieving component 215, and/or symbol file transmitting component 216 (FIGS. 1-2). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

What is claimed is:

1. A method for transmitting symbol files, comprising:
storing one or more symbol files at a local server;
identifying a symbol file associated with a crash dump file by parsing the crash dump file;
determining whether the identified symbol file is to be transmitted to a central symbol server;
retrieving the identified symbol file from the local server based at least on the determining; and
transmitting the retrieved symbol file to the central symbol server based at least on the determining.

2. The method of claim 1, wherein the crash dump file is embedded with a read-only unique identifier of an associated symbol file.

3. The method of claim 1, wherein each of the one or more symbol files are embedded with a read-only unique identifier.

4. The method of claim 1, wherein a symbol file stored at the local server is customized.

5. The method of claim 1, wherein the identifying further comprises:
extracting a unique identifier associated with a symbol file from the crash dump file; and
matching the extracted unique identifier to a symbol file stored at the local server.

6. The method of claim 1, wherein the parsing further comprises:
searching and reading the crash dump file asynchronously.

7. The method of claim 1, wherein the determining comprises:
searching a database at the local server to determine whether the identified symbol file was transmitted before to the central symbol server.

8. The method of claim 7, further comprising:
determining that the retrieved symbol file was not transmitted earlier to the central symbol server;
transmitting the retrieved symbol file to the central symbol server based at least on the determining; and
updating the database at the local server.

9. The method of claim 1, wherein the transmitted symbol file is configured with an expiration date prior to the transmitting.

10. The method of claim 1, wherein the transmitted symbol file can be set for a private or a public access prior to the transmitting.

11. An apparatus for transmitting symbol files, comprising:
means for storing one or more symbol files at a local server,
means for identifying a symbol file associated with a crash dump file by parsing the crash dump file;
means for determining whether the identified symbol file is to be transmitted to a central symbol server;
means for retrieving the identified symbol file from the local server based at least on the determining; and
means for transmitting the retrieved symbol file to the central symbol server based at least on the determining.

12. The apparatus of claim 11, wherein the crash dump file is embedded with a read-only unique identifier of an associated symbol file.

13. The apparatus of claim 11, wherein a symbol file stored at the local server is customized.

14. The apparatus of claim 11, wherein the identifying further comprises:
extracting a unique identifier associated with a symbol file from the crash dump file; and
matching the extracted unique identifier to a symbol file stored at the local server.

15. The apparatus of claim 11, wherein the parsing further comprises:
searching and reading the crash dump file asynchronously.

16. A computer program product for transmitting symbol files, comprising: a computer-readable medium comprising:
storing one or more symbol files at a local server;
identifying a symbol file associated with a crash dump file by parsing the crash dump file;
determining whether the identified symbol file is to be transmitted to a central symbol server;
retrieving the identified symbol file from the local server based at least on the determining; and
transmitting the retrieved symbol file to the central symbol server based at least on the determining.

17. The method of claim 16, wherein the crash dump file is embedded with a read-only unique identifier of an associated symbol file.

18. The method of claim 16, wherein a symbol file stored at the local server is customized.

19. The method of claim 16, wherein the identifying further comprises:
extracting a unique identifier associated with a symbol file from the crash dump file; and
matching the extracted unique identifier to a symbol file stored at the local server.

20. The method of claim 16, wherein the parsing further comprises:
searching and reading the crash dump file asynchronously.

21. An apparatus for transmitting symbol files, comprising:
a symbol file storing component configured to store one or more symbol files at a local server;
a symbol file identifying component configured to identify a symbol file associated with a crash dump file by parsing the crash dump file;
a symbol file transmitting detecting component configured to determine whether the identified symbol file is to be transmitted to a central symbol server;
a symbol file retrieving component configured to retrieve the identified symbol file from the local server based at least on the determining; and
a symbol file transmitting component configured to transmit the retrieved symbol file to the central symbol server based at least on the determining.

22. The apparatus of claim 21, wherein the crash dump file is embedded with a read-only unique identifier of an associated symbol file.

23. The apparatus of claim 21, wherein each of the one or more symbol files are embedded with a read-only unique identifier.

24. The apparatus of claim 21, wherein a symbol file stored at the local server is customized.

25. The apparatus of claim 21, wherein the symbol file identifying component is further configured to:
extract a unique identifier associated with a symbol file from the crash dump file; and
match the extracted unique identifier to a symbol file stored at the local server.

26. The apparatus of claim 21, wherein the symbol file identifying component is further configured to comprise a parsing component configured to:
search and read the crash dump file asynchronously.

27. The apparatus of claim 21, wherein the symbol file transmitting detecting component is further configured to:
search a database at the local server to determine whether the identified symbol file was transmitted to the central symbol server.

28. The apparatus of claim 27, wherein the symbol file transmitting detecting component is further configured to:
update the database at the local server and transmit the retrieved symbol file to the central symbol server based at least on the determining that the retrieved symbol file was not transmitted to the central symbol server.

29. The apparatus of claim 21, wherein the symbol file transmitting component is further configured to configure the symbol file with an expiration date prior to the transmitting.

30. The apparatus of claim 21, wherein the symbol file transmitting component is further configured to set a private or a public access prior to the transmitting.
